(19) United States
(12) Patent Application Publication
(10) Pub. No.: US 2004/0121080 A1
(43) Pub. Date: Jun. 24, 2004

(54) Method of producing a coated substrate

(76) Inventors: Robert Urscheler, Horgen (CH); John A. Roper III, Midland, MI (US); Pekka J. Salminen, Galgenin (CH); Francis Dobler, Binz (CH)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/691,890

(22) Filed: Oct. 16, 2003

Related U.S. Application Data
(63) Continuation-in-part of application No. 10/273,866, filed on Oct. 17, 2002, now abandoned.

(51) Int. Cl. B05D 1/36; B05D 1/30

(52) U.S. Cl. 427/420; 427/402

(57) ABSTRACT

The present invention refers to a method of producing a coated substrate comprising the steps of:

a) forming a free flowing curtain, the curtain having at least one component capable of reacting, and

b) contacting the curtain with a continuous web substrate.

### CROSS REFERENCE TO RELATED APPLICATIONS

This application is a continuation-in-part of U.S. application Ser. No. 10/273,866, filed Oct. 17, 2002, which is a continuation-in-part of U.S. application Ser. No. 10/257,172, filed Apr. 12, 2002.

### BACKGROUND OF THE INVENTION

This invention relates to a method of producing coated substrates. In a further embodiment the present invention relates to a method of producing coated paper or paperboard.

In the manufacturing of coated substrates, coating compositions usually are applied to said substrate by, for example, blade type, bar type, or reverse roll type coating methods. The line speed may exceed 1,000 m/min. Any or all of these methods are commonly employed to sequentially apply coatings to the moving substrates.

However, each of these application methods inherently has its own set of problems that can result in an inferior coated surface quality. In the case of the blade type coating method, the lodgment of particles under the blade can result in streaks in the coating layer, which lowers the quality of the coated paper or paperboard. In addition, the high pressure that must be applied to the blade to achieve the desired coating weight places a very high stress on the substrate and can result in breakage of the substrate web, resulting in lowered production efficiency. Moreover, since the pigmented coatings are highly abrasive, the blade must be replaced regularly in order to maintain the evenness of the coated surface. Also, the distribution of the coating on the surface of the paper or paperboard substrate is affected by the surface irregularities of the substrate. An uneven distribution of coating across the paper or paperboard-surface can result in a dappled or mottled surface appearance that can lead to an inferior printing result.

The bar (rod) type coating method is limited as to the solids content and viscosity of the pigmented coating color that is to be applied. Pigmented coatings applied by the bar type coating method are typically lower in solids content and viscosity than pigmented coating colors applied by the blade type method. Accordingly, for the bar type coating method it is not possible to freely change the amount of coating that can be applied to the surface of the paper or paperboard substrate. Undesirable reductions in the quality of the surface of the coated paper or paperboard can result when the parameters of coating solids content, viscosity and coatweight are imbalanced. Moreover, abrasion of the bar by the pigmented coatings requires that the bar be replaced at regular intervals in order to maintain the evenness of the coated surface.

The roll type (film) coating method is a particularly complex process of applying pigmented coatings to paper and paperboard in that there is a narrow range of operating conditions related to substrate surface characteristics, substrate porosity, coating solids content and coating viscosity that must be observed for each operating speed and each desired coatweight to be achieved. An imbalance between these variables can lead to an uneven film-split pattern on the surface of the coated paper, which can lead to an inferior printing result, or the expulsion of small droplets of coating as the sheet exits the coating nip. These droplets, if re-deposited on the sheet surface, can lead to an inferior printing result. Moreover, the maximum amount of coating that can be applied to a paper or paperboard surface in one pass using the roll type coating method is typically less than that which can be applied in one pass by the blade or bar type coating methods. This coating weight limitation is especially pronounced at high coating speeds.

A common feature of all these methods is that the amount of coating liquid applied to a paper web, which generally has an irregular surface with hills and valleys, is different depending on whether it is applied to a hill or a valley. Therefore, coating thickness, and thus ink reception properties, will vary across the surface of the coated paper resulting in irregularities in the printed image. Despite their drawbacks, these coating methods are still the dominant processes in the paper industry due to their economics, especially since very high line speeds can be achieved.

A feature common to all of the mentioned coating techniques is that an excess of coating liquid is applied to the substrate and then is metered off. In the case of a reactive coating, which is a coating comprising reagents capable of reacting with each other, the reaction occurring in the metered excess coating renders it useless. Furthermore, each of these coating methods have, as already mentioned, rheological constraints for obtaining good runnability so that the addition of a reactive additive may change the coating rheology profile so that it falls outside of the window of coatability. There are cases where reactive chemistries are used to impart functionality to the coated substrate; however, these coatings are applied through the use of a subsequent coating or converting step that adds complexity and expense.

Curtain coating is a relatively new coating technique. EP-A 517 223, and Japanese patent applications JP-94-89437, JP-93-311931, JP-93-7781-6, JP-93-131718, JP-92-298683, JP-92-51933, JP-91-298229, JP-90-217327, and JP-8-310110 disclose the use of curtain coating methods to apply one or more pigmented coating layers to a moving paper surface. More specifically, the prior art relates to:

(i) The curtain coating method being used to apply a single layer of pigmented coating to a basepaper substrate to produce a single-layer-pigmented coating on paper.

(ii) The curtain coating method being used to apply a single priming layer of Pigmented coating to a basepaper substrate prior to the application of a single layer of pigmented topcoat applied by a blade type coating process. Thus a multilayer-pigmented coating of paper was achieved by sequential applications of pigmented coating.

(iii) The curtain coating method being used to apply a single topcoating layer of pigmented coating to a basepaper substrate that has previously been primed with a single layer of pigmented precoat that was applied by a blade or a metering roll type coating process. Thus a multilayer-pigmented paper coating was achieved by sequential applications of pigmented coating.

(iv) The curtain coating method being used to apply two single layers of specialized pigmented coating to a basepaper substrate such that the single layers are applied in consecutive processes. Thus a multilayer-pigmented coating of paper was achieved by sequential applications of pigmented coating.

The use of a curtain coating method to apply a single layer of pigmented coating to the surface of a moving web of paper, as disclosed in the prior art discussed above, is stated to offer the opportunity to produce a superior quality coated paper surface compared to that produced by conventional means. However, the sequential application of single layers of pigmented coating using curtain coating techniques is constrained by the dynamics of the curtain coating process. Specifically, lightweight coating applications can only be made at coating speeds below those currently employed by conventional coating processes because at high coating speeds the curtain becomes unstable, and this results in an inferior coated surface. Unfortunately, the application of consecutive single layers of pigmented coatings to paper or paperboard at successive coating stations, whether by any of the above coating methods, remains a capital-intensive process due to the number of coating stations required, the amount of ancillary hardware required, for example, drive units, dryers, etc., and the space that is required to house the machinery.

Coated papers and paperboards that have received a coating that contains an additive designed to impart functional properties, such as barrier properties, printability properties, adhesive properties, release properties, and optical properties such, as color, brightness, opacity, gloss, etc., are Described as functional products and their coatings may be referred to as functional coatings. The coating components that impart these properties may also be referred to as functional additives. Functional products include paper types such as self adhesive papers, stamp papers, wallpapers, silicone release papers, food packaging, grease-proof papers, moisture resistant papers, and saturated tape backing papers.

The curtain coating method for the simultaneous coating of multiple layers is well known and is described in U.S. Pat. Nos. 3,508,947 and 3,632,374 for applying photographic compositions to paper and plastic web. However, photographic solutions or emulsions have a low viscosity and a low solids content, and are applied at low coating speeds.

In addition to photographic applications, the simultaneous application of multiple coatings by curtain coating methods is known from the art of making pressure sensitive copying paper. For example, U.S. Pat. No. 4,230,743 discloses in one embodiment the simultaneous application of a base coating comprising microcapsules as a main component and a second layer comprising a color developer as a main component onto a travelling web. However, it is reported that the resulting paper has the same characteristics as the paper made by sequential application of the layers. Moreover, the coating composition containing the color developer is described as having a viscosity between 10 and 20 cps at 22° C.

JP-A-10-328613 discloses the simultaneous application of two coating layers onto a paper web by curtain coating to make an inkjet paper. The coating compositions applied according to the teaching of that reference are aqueous solutions with an extremely low solids content of 8% by weight. Furthermore a thickener is added in order to obtain non-Newtonian behavior of the coating solutions. The examples in JP-A-10-328613 reveal that acceptable coating quality is only achieved at line speeds below 400 m/min. The low operation speed of the coating process is not suitable for economic production of printing paper, especially commodity printing paper.

In view of the deficiencies of conventional commercial paper coating techniques, it would be desirable to have a process capable of improving the properties of a coated substrate, such as printing quality of the resulting coated substrate.

### SUMMARY OF THE INVENTION

The technical problem underlying the present invention is to overcome the disadvantages of the prior art and, thus, to provide a coating method capable of applying coatings comprising one or more reactive compounds. A further aspect of the present invention is to provide a coating method whereby the properties of the applied coating is not detrimentally affected by the presence of reagents in the coating capable of reacting with each other. Moreover, a further aim of the present invention is to provide coated substrates having improved properties and a method of producing the same.

The technical problem of the present invention is solved by a method of producing a coated substrate comprising the steps of:

a) forming a free flowing curtain, the curtain having at least a first component and a second component capable of reacting with each other, and

b) contacting the curtain with a continuous web substrate.

In one embodiment, the present invention is a method of producing a coated substrate comprising the steps of:

a) forming a composite, multilayer free flowing curtain, the curtain having at least two layers, whereby one layer comprises at least a first component that is capable of reacting with at least a second component comprised in the other layer, and

b) contacting the curtain with a continuous web substrate.

In a preferred embodiment there is at least one internal layer present between the layer comprising the first component and the layer comprising the second component.

In a further embodiment, the problem of the invention is solved by a process for producing a coated substrate comprising the steps of:

a) forming a free flowing curtain, the curtain having at least one component capable of reacting with itself or another compound, and

b) contacting the curtain with a continuous web substrate,

wherein at least one component of the curtain begins reacting during the coating process and is essentially completely reacted before the coating process is complete.

In another embodiment, the problem of the present invention is solved by a method of producing a coated substrate comprising the steps of:

a) forming a free flowing curtain, the curtain having at least one layer comprising a composition capable of reacting; and

b) contacting the curtain with a continuous web substrate.

### DETAILED DESCRIPTION OF THE INVENTION

The composition forming the at least one layer of the free flowing curtain of step a) may comprise at least one first component and at least one second component capable of reacting with each other or may contain a reaction system wherein reaction of at least one reactive component can be induced by means of catalyst, initiator or activator present in the composition or by exposure to energy such as heat or radiation. As used herein, the term “reactive component” means a material that is capable of reacting and/or a material that initiates, catalyzes or is otherwise involved in a reaction. As used herein, the term “coating process” means a process comprising coating a substrate to a point such that the coating is immoblized and/or the coated substrate is finished and ready for sale.

Preferably, said free flowing curtain of step a) is a composite multilayer free flowing curtain.

Preferably, there are three main means by which the curtain coating can be used to apply reactive coatings:

1) Precoat reaction—the first and second component capable of reacting with each other are added to the coating liquid just before or when said coating liquid passes through the curtain coating head, possibly through the use of inline mixing;

2). Coating reaction—where two or more reactive layers are prepared and brought together in the falling curtain so that the reaction can begin during the coating application process; and

3). Postcoat reaction—where at least one reactive layer is introduced into the coating and the reaction takes place after said coating is applied to the substrate but before the coated substrate is in its finished form.

Thus, preferably the reaction between the first component and the second component of step a) takes place within the coating die or head, in the free flowing curtain and/or when applied to the substrate, and/or when initiated by, for example, pressure, heat, pH change, radiation and/or exposure to a gas or vapor, such as oxygen or ammonia.

The reaction type of which the first component and the second component of step a) react with each other is not limited, and may be, for example: an anionic-cationic interaction; a crosslinking reaction; a free radical reaction; a step growth reaction; a addition reaction; a curing reaction such as a UV induced curing reaction, an oxygen induced curing reaction, a catalyzed reaction or an electron beam induced curing reaction; an acid base reaction; a grafting reaction; a ring opening reaction; a precipitation; a phase change; a flocculation/coagulation reaction or a combination thereof. Examples of reactive first and second component combinations include, for example, the following: a polyvinyl alcohol and borax; a cationic starch and an anionic coating composition; a starch and a dialdehyde; an epoxy-functional polymer, and an amine hardening agent; and a polyisocyanate and a polyol. In a preferred embodiment of the invention, the reaction involved in the coating process proceeds readily at room temperature in the substantial absence of external energy

In a preferred embodiment it is excluded that a cross linking reaction takes place between the at least first component and at least second component if said components are present in the same layer. Preferably, the process of the invention is conducted in the substantial absence of electron beam radiation.

In a further preferred embodiment it is excluded that a flocculation can be induced by adding calcium chloride solution to a coating composition.

The term anionic-cationic interaction refers to the reaction of an anionic compound with a cationic compound in a coating liquid, whereby the properties of said coating liquid change due to said anionic-cationic, interaction. The property change, may be a flocculation that would make it impossible to apply said coating to substrates using blade, rod, or airbrush (air knife) coating techniques.

The substrate of the present invention preferably is a basepaper or paperboard so that a coated basepaper or paperboard is produced accordingly.

In a preferred embodiment, photographic papers and/or pressure sensitive copying papers are excluded from the scope of the present invention. The term “excluding photographic papers should be interpreted in the sense that none of the layers of the curtain used in the practice of the present invention comprise silver compounds. The term “excluding pressure sensitive copying papers” should be interpreted in the sense that the layers of the curtain do not contain a combination of a microencapsulated color former and a color developer in a single layer or in different layers.

The curtain layers can be simultaneously applied according to the present invention by using a curtain coating unit with a slide nozzle arrangement for delivering multiple liquid layers to form a continuous, multilayer curtain. Alternatively, an extrusion type supplying head, such as a slot die or nozzle having several adjacent extrusion nozzles, can be employed in the practice of the present invention. In a preferred embodiment, the entire coating liquid that passes through the curtain coating unit is applied to the substrate. Preferably, on the edges of the formed curtain only a minor part of coating liquid is removed before said curtain is applied to the substrate. Coating liquids that pass through the curtain coating unit and that are not applied to the substrate may be discarded.

According to a preferred embodiment of the present invention at least one curtain layer of the free falling curtain comprises at least one pigment. Preferably, in making a paper for printing purposes at least two of the coating layers comprise at least one pigment. Preferably, a top layer ensuring printability is present. Said layer improves surface properties like gloss or smoothness and optionally is not pigmented. For the manufacture of commodity printing paper, coating with two pigmented layers is sufficient for most purposes.

The present inventors have surprisingly discovered that coated substrates, such as paper and paperboard, with improved properties can be readily prepared using coating formulations comprising reactive components via the process of the invention.

The curtain employed in the invention has a bottom, or interface, layer, and optionally a top layer, and/or optionally one or more internal layers. Each layer comprises a liquid, emulsion, suspension, dispersion or solution. The coating curtain of the present invention suitably includes at least one layer, and also includes embodiments having at least 2, at least 3, at least 4, at least 5, or at least 6 or more layers. The layers of the curtain can include one or more printing layers, one or more functional layers, one or more spacing layers, one or more coating layers, and one or more layers imparting reactive functionalities, and the like, or any combination thereof. A spacing layer is a layer that separates at least two other layers. For example, a spacing layer can be employed between layers having reactive components in order to delay the initiation of a reaction involving the components.

In a preferred embodiment, there is at least one internal layer present between the layer comprising the first component and the layer comprising the second component.

A coating layer of the invention preferably comprises at least one pigment and/or binder, and can be formulated to be the same or different than conventional paper coating formulations. The primary function of a coating layer is to cover the surface of the substrate as is well known in the paper-coating art. Conventional coating formulations, referred to in the industry as coating colors, can be employed as the coating layer. Examples of pigments useful in the process of the present invention include clay, kaolin, talc, calcium carbonate, titanium dioxide, satin white, synthetic polymer pigment, zinc oxide, barium sulphate, gypsum, silica, alumina trihydrate, mica, and diatomaceous earth. Kaolin, talc, calcium carbonate, titanium dioxide, satin white and synthetic polymer pigments, including hollow polymer pigments, are particularly preferred. A wide variety of pigments are commercially available. Mixtures of pigments can be employed.

Binders useful in the practice of the present invention include, for example, styrene-butadiene latex, styrene-acrylate latex, styrene-acrylate-acrylonitrile latex, styrene-butadiene-acrylate-acrylonitrile latex, styrene-butadiene-acrylonitrile latex, styrene-maleic anhydride latex, styrene-acrylate-maleic anhydride latex, polysaccharides, protein, polyvinyl pyrrolidone, polyvinyl alcohol, polyvinyl acetate, epoxy resin, cellulose derivatives, and polyurethane. Examples of preferred binders include carboxylated styrene-butadiene latex, carboxylated styrene-acrylate latex, carboxylated styrene-butadiene-acrylonitrile latex, carboxylated styrene-maleic anhydride latex, carboxylated polysaccharides, proteins, polyvinyl alcohol, and carboxylated polyvinyl acetate latex Examples of polysaccharides include agar, sodium, alginate, and starch, including modified starches such as thermally modified starch, carboxymethylated starch, hydroxyethylated starch, and oxidized starch. Examples of proteins that can be employed in the process of the present invention include albumin, soy protein, and casein. A wide variety of suitable binders are commercially available. Mixtures of binders can be employed.

When a multilayer curtain is employed, the coatweight of each layer of the curtain can be adjusted to obtain the desired coated substrate properties. Preferably, the dry coatweight of each layer is from about 0 to about 30 g/cm². At least one of the layers of the multilayer curtain desirably has a dry coatweight of less than about 30 g/m², preferably less than about 20 g/m², more preferably less than about 10 g/m², even more preferably less than about 5 g/m², and most preferably less than about 3 g/m². An individual layer of the curtain can have a dry coatweight of about 0 g/m² when it contains no solids.

The curtain of the invention comprises an interface layer, that is the layer that comes in contact with the substrate to be coated. One important function of the interface layer may be to promote wetting of the substrate paper. The interface layer can have more than one function. For example, in addition to wetting it may provide coverage of the substrate and improved functional performance such as adhesion, sizing, stiffness or a combination of functions. The interface layer can include a reactive component or can be free of reactive compounds. This layer is preferably a relatively thin layer when employed in a multilayer curtain. The coatweight of the interface layer when employed in a multilayer curtain preferably is from about 0.01 to about 5 g/m², and more preferably is from about 1 to about 3 g/m².

In a preferred embodiment of the invention, the interface layer includes one or more of the following: a dispersion such as a latex, including an alkali swellable latex, a blend of starch and poly(ethylene acrylic acid) copolymer, and the like, or a water soluble polymer, such as, for example, polyvinyl alcohol, a starch, an alkali soluble latex, a polyethylene, oxide, or a polyacrylamide. The interface layer can optionally be pigmented, and this is preferred for certain applications.

The curtain of the invention can include one or more functional layers. The purpose of a functional layer is to impart a desired functionality to the coated paper. Functional layers can be selected to provide for example, at least one of the following: printability; barrier properties, such as moisture barrier, aroma barrier, water and/or water vapor barrier, solvent barrier, oil barrier, grease barrier and oxygen barrier properties; sheet stiffness; fold crack resistance; paper sizing properties; release properties; adhesive properties; and optical properties, such as color, brightness, opacity and gloss; etc. In one embodiment of the invention, the first and second reactive components can react to impart functionality to a layer in the coating. Functional coatings that are very tacky in character would not normally be coated by conventional consecutive coating processes because of the tendency of the tacky coating material to adhere the substrate to guiding rolls or other coating equipment. The simultaneous multilayer coating method of the invention, on the other hand, allows such functional coatings to be placed underneath a topcoat that shields the functional coating from contact with the coating machinery.

The solids content of a functional layer can vary widely depending on the desired function. A functional layer of the present invention preferably has a solids content of up to about 75% by weight based on the total weight of the functional layer and a viscosity of up to about 10,000 cps (Brookfield, spindle 5, 100 rpm, 25° C.), more preferably about 50 to about 3,000 cps. Preferably, the coatweight of a functional layer is from about 0.1 to about 30 g/m², more preferably about 0.5 to about 10 g/m², and most preferably from about 1 to about 3 g/m². In certain situations, such as, for example, when a dye layer is employed or in the case of certain reactants such as borax, the coatweight of the functional layer can be less than about 0.1 g/m².

The functional layer of the present invention can contain, for example, at least one of the following: a polymer of methylene acrylic acid; a polyethylene; other polyolefins; a polyurethane; an epoxy resin; a polyester; an adhesive such as a styrene butadiene latex, a styrene acrylate latex, a carboxylated latex, a starch, a protein, or the like; a sizing agent such as a starch, a styrene-acrylic copolymer, a styrene-maleic anhydride, a polyvinyl alcohol, a polyvinyl acetate, a carboxymethyl cellulose or the like; and a barrier such as silicone, a wax or the like.

Each functional layer can include, but is not limited to include, at least one pigment and/or binder as previously described for the coating layer, and/or one or more reactive components.

If desired, at least one additive such as, for example, at least one dispersant, at least one lubricant, at least one water retention agent, at least one surfactant, at least one optical brightening agent, at least one pigment dye or colorant, at least one thickening agent, at least one defoamer, at least one anti-foaming agent, at least one biocide, at least one soluble dye or colorant, including any combination of these or the like may be used in at least one layer of the curtain. Polyethylene oxide is an example of a preferred additive, and can be employed in any layer. In a preferred embodiment, polyethylene oxide is employed as a thickening agent, preferably at least in the interface layer. Advantageously, the polyethylene oxide has a weight average molecular weight of at least about 50,000, preferably at least about 100,000, more preferably at least about 500,000, and most preferably at least about 800,000. Preferably, the amount of polyethylene oxide employed is sufficient to prevent cratering, and is preferably less than about 2 wt. %, based on the weight of solids in the layer in which it is employed.

For the purposes of the present invention, in a multilayer curtain the layer most distant from the substrate paper is referred to as the top layer. This layer typically is the layer that will be printed upon, although it is possible that the coated paper of the present invention could also be further coated using conventional means, such as rod, blade, roll, bar, or air knife (airbrush) coating techniques, and the like. The top layer can be a coating layer or a functional layer, including a gloss layer, and can contain a reactive component. In a preferred embodiment of the invention, the top layer is very thin, having a, coatweight of, for example, from about 0.5 to about 3 g/m². This advantageously allows the use of less expensive materials under the top layer, while still producing a paper having good printing properties. In one embodiment, the top layer is free of mineral pigment.

According to a particularly preferred embodiment, the top layer comprises a glossing formulation. The novel combination of glossing formulation and simultaneous multilayer curtain coating combines the advantages of curtain coating with good gloss. The glossing formulations useful in the present invention comprise gloss additives, such as synthetic polymer pigments, including hollow or solid polymer pigments, produced by polymerization of, for example, styrene, acrylonitrile and/or acrylic monomers. The synthetic polymer pigments preferably have a glass transition temperature of about 40 to about 200° C., more preferably about 50 to about 130° C., and a particle size of about 0.02 to about 10 μm more preferably about 0.05 to about 2 μm. The glossing formulations contain about 5 to about 100 wt. %, based on solids, of gloss additive, more preferably about 60 to about 100 wt. %. Another type of glossing formulation comprises gloss varnishes, such as those based on epoxyacrylates, polyesters, polyesteracrylates, polyurethanes, polyetheracrylates, oleoresins, nitrocelluloses, polyamides, vinyl copolymers and various forms of polyacrylates. According to a preferred embodiment of the present invention the viscosity of the top layer is greater than about 20 cps (at 25° C.). A preferred viscosity range is from about 90 cps to about 2,000 cps, more preferably from about 200 cps to about 1,000 cps.

When the curtain has at least 3 layers, then it has at least one internal layer. The viscosity and solids content of the internal layer(s) is not critical, provided a stable curtain can be maintained. The internal layer preferably is a functional layer or a coating layer. When more than one internal layer is present, combinations of functional and coating layers can be employed. For example, the internal layers can comprise a combination of identical or different functional layers, a combination of identical or different coating layers, or a combination of coating and functional layers. An internal layer may contain a reactive component.

The process of the invention expands the limits of paper coating technology, gives the coated paper producer unprecedented flexibility, and the ability to prepare novel coated papers.

Preferably, the free flowing curtain desirably has a solids content of at least about −10 wt. %, preferably at least about 40 wt. %, more preferably at least about 45 wt. %, and most preferably at least about 50 wt. %. Advantageously, the free flowing curtain has a solids content of from about 10 to about 80 wt. %. At least one layer of a multilayer free flowing curtain of the invention preferably has a solids content of at least about 40 wt. %, preferably at least about 50 wt. %, and most preferably at least about 65 wt. %.

A particular advantage of one embodiment of the present invention is that, by the simultaneous application of at least two coating layers by curtain coating, very thin layers or in other words very low coatweights of the respective layers can be obtained even at very high application speeds. For example, the coatweight of each layer in the composite curtain can be from about 0.01 to about 10 g/M², more preferably about 0.1 to about 3 g/m². The coatweight of each layer can be the same as the others, or can vary widely from the other layers; thus, many combinations are possible.

The process of the invention can produce substrates having a wide range of coatweights. Preferably, the coatweight of the coating on the paper produced is from about 3 to about 60 g/m², more preferably from about 5 to about 25 g/m². The coating prepared from the curtain desirably has a dry coatweight of less than about 60 g/m², alternatively less than about 30 g/m², alternatively less than about 20 g/m², alternatively less than about 15 g/m², alternatively less than about 12 g/m², alternatively less than about 10 g/m², and most preferably less than about 5 g/m².

In one embodiment of the present invention the coatweight of the top layer is lower than the coatweight of the layer contacting the basepaper or baseboard. Preferably, the coatweight of the top layer is less than about 75%, more preferably less than about 50%, of the coatweight of the layer contacting the basepaper or baseboard. Thus, greater coating raw material efficiencies in the paper and paperboard coating operations is achieved. In another embodiment, the coatweight of the top layer is higher than the coatweight of the layer(s) below it. Unlike conventional coating processes, the simultaneous multilayer coating method of the present invention allows the use of much larger quantities of relatively inexpensive raw materials such as, for example, under an extremely thin top, layer of more expensive raw materials or in combination with an expensive reactant, such as a curing agent, without compromising the quality of the finished coated product. In addition, the method of the invention allows the preparation of papers that have never been produced before. For example, a tacky functional internal layer can be included in the curtain.

A pronounced advantage of the present invention irrespective of which embodiment is used is that the process of the present invention can be run at very high coating speeds that hitherto in the production of printing paper could only be achieved using blade, bar or roll application methods. Usual line speeds in the process of the invention are at least about 300 m/min, preferably at least about 400 m/min, more preferably at least about 500 m/min, such as in a range of about 600 to about 3200 m/min, and more preferably at least about 800 m/min, such as in a range of about 800 to about 2500 m/min. In one embodiment of the invention, the line speed, or speed of the moving substrate, is at least about 1000 m/min, preferably at least about 1500 m/min.

Preferably, the continuous web substrate of step b) is neither precoated nor precalendered. In another embodiment, the continuous web substrate of step b) is not precoated, and in a further embodiment the continuous web substrate of step b) is not precalendered. The continuous web substrate of step b) preferably has a grammage, or basis weight, of from about 20 to about −400 g/m².

### BRIEF DESCRIPTION OF THE DRAWING

FIG. 1 is an explanatory cross-sectional view of a curtain coating unit 1 with a slide nozzle arrangement 2 for delivering multiple streams 3 of curtain layer to form a continuous, multilayer curtain 4. When a dynamic equilibrium state is reached, the flow amount of the curtain layers flowing into the slide nozzle arrangement 2 is completely balanced with the flow amount flowing out of the slide nozzle arrangement. The free falling multilayer curtain 4 comes into contact with web 5, which is running continuously, and thus the web 5S is coated with the multilayer curtain. The running direction of the web 5 is changed immediately before the coating area by means of a roller 6 to minimize the effect of air flow accompanying the fast moving web 5.

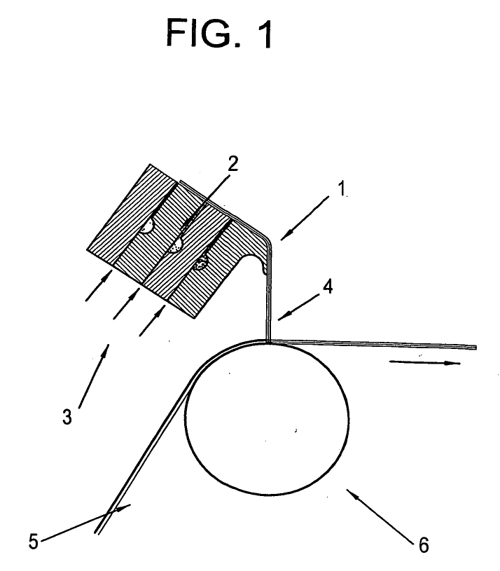

An advantage of the process of the present invention over the prior art is that a coated substrate having specific properties can be obtained by applying a curtain comprising at least two reactive compounds to a substrate. Said method allows one to prepare a coated substrate having specific layers imparting due to the reaction of said reactive compounds, specific properties. As the methods known in the prior art apply an excess of coating color, they cannot effectively apply coatings comprising reactive compounds to substrates.

Preferably, the coated substrates can be printed using any printing method known to a person skilled in the art.

### SPECIFIC EMBODIMENTS OF THE INVENTION

The present invention is exemplified by the following examples. All parts and percentages are by weight unless otherwise specified.

The following materials are used to make the layers in the reactive coating structure:

Ameo: 3-aminopropyl-triethoxysilane (DYNASYLAN AMEO available from Degussa AG, Hanau, Germany).

Carbonate (A): dispersion of calcium carbonate with particle size of 90%<2 μm in water (HYDROCARB 90 ME available from Pluess-Stauffer), 77% solids.

Carbonate (B): dispersion of calcium carbonate with particle size of 60%<2 μm in water (HYDROCARB 60 ME available from Pluess-Stauffer, Oftringen, Switzerland), 77% solids.

Catalyst: an organo tin complex of dibutyltin dilaurate (available from Air Products, Allentown, Pa., USA).

Clay: dispersion of No. 1 high brightness kaolin clay with particle size of 98%<2 μm in water (HYDRAGLOSS 90 available from J.M Huber Corp., Have de Grace, Md., USA), 71% solids.

Epoxy: dispersion of a bisphenol A based epoxy resin with a 500 epoxy equivalent weight based on solids, 55% solids in water.

DSP: dispersion of an ethylene acrylic acid copolymer (DSP 70 available from The Dow Chemical Company) 15% solids in water.

Glyeo: 3-glycidyloxypropyl-triethoxysilane (DYNASILAN GLYEO available from Degussa AG, Hanau, Germany).

Glyoxal: a reactive polyhydroxylated dialdehyde resin (Cartabound GH Liquid available from Clariant AG Lorrach Germany).

Hardener: an amino based epoxy curing agent with an amino-epoxy equivalent weight of 240 based on solids, (XZ 92441.01 available from The Dow Chemical Company) 75% solids in water.

Isocyanate: aliphatic poly-isocyanate of hexamethylene-1,6-diisocyanate (Bayhydur VP LS 2319 available from Bayer AG, Leverkusen, Germany).

Latex (A): carboxylated styrene-butadiene latex (DL 966 available from The Dow Chemical Company), 50% solids in water.

Latex (B): carboxylated styrene-butadiene latex (DL 980 available from The Dow Chemical Company), 50% solids in water.

Latex (C): alkali swellable carboxylated acrylate latex (XZ 92338 available from The Dow Chemical Company), 27% solids in water.

Latex (D): carboxylated acrylate latex (XU-31215.5 available from The Dow Chemical Company), 51% solids in water.

Latex E: carboxylated acrylate latex (UCAR Latex DT 211 available from The Dow Chemical Company) 50.5% solids in water.

Latex F: carboxylated styrene butadiene latex (DL 939 available from The Dow Chemical Company) 50% solids in water.

Polyethylene oxide: a 300 molecular weight polyethylene oxide (PEG 300 available from Fluka).

PVOH: solution of 15% of low molecular weight synthetic polyvinyl alcohol (MOWIOL 6/98 available from Clariant AG, Basel Switzerland).

Surfactant (A): aqueous solution of sodium di-alkylsulphosuccinate (AEROSOL OT available from: Cyanamid, Wayne, N.J., USA), 75% solids.

Surfactant (B): TERGITOL TMN 6 aqueous solution of trimethylnonanol ethoxylate 6 EO (available from The Dow Chemical Company), 90% solids.

Thickening agent: a 900,000 molecular weight non-ionic water-soluble poly(ethylene oxide) polymer (POLYOX WSR-1105 available from The Dow Chemical Company), 4% solids in water.

Whitener: fluorescent whitening agent derived from diamino-stilbenedisulfonic acid (TINEPOL ABP/Z, available from Ciba Specialty Chemicals Inc. Basel, Switzerland).

Borax: sodium tetra borate purity >98%, available from FLUKA.

Starch (A): Cationic Starch (C Size SP 5855 available from Cerestar, Krefeld, Germany).

Starch (B): Anionic Starch (C Film 07311 available from Cerestar, Krefeld, Germany).

Coating Method

The above ingredients are mixed in the amounts given in tables hereinbelow, where all parts are based on dry weights unless otherwise indicated. The pH of the pigmented coating formulations are adjusted by adding NaOH solution (10%) as indicated in Table 1. Water is added as needed to adjust the solids content of the formulations. The formulations are coated onto paper according to one of the following procedures.

Coating Procedure 1: A multilayer slide die type curtain coater manufactured by Troller Schweizer Engineering (TSE, Murgenthal, Switzerland) is used. The curtain coating apparatus is equipped with edge guides lubricated with a trickle of water and with a vacuum suction device to remove this edge lubrication water at the bottom of the edge guide just above the coated paper edge. Volumetric pumps are employed to provide precise volumes to the die in order to achieve the desired coatweights. In addition, the curtain coater is equipped with a vacuum suction device to remove interface surface air from the paper substrate upstream from the curtain impingement zone. The height of the curtain is 300 mm. Coating formulations are deaerated prior to use to remove air bubbles. After coating on the web the paper is dried with a hot air drier.

Coating Procedure 2: This procedure is identical to Coating Procedure 1 except for the following differences. The formulations are coated onto paper using a multilayer slide die type curtain coater, manufactured by Leuthold AG. When volatile components are present in the formulation, the formulations are poured into the feed containers at least 12 hours before application, without stirring, so natural deaeration could take place. When two coating formulations needed, to be reacted just before entering the slide die they are pumped through a small closed vessel and agitated by a paddle at up to 600 rpm.

Test Methods

Brookfield Viscosity

The viscosity is measured using a Brookfield RVT viscometer (available from Brookfield Engineering Laboratories, Inc., Stoughton, Mass., USA). For viscosity determination, 600 ml of a sample are poured into a 1000 ml beaker and the viscosity is measured at 25° C. at a spindle speed of 100 rpm.

Paper Gloss

Paper gloss is measured using a Zehntner ZLR-1050 instrument at an incident angle of 75°.

Ink Gloss

The test is carried out on a Pruefbau Test Printing unit with Lorrilleux Red Ink No. 0.8588. An amount of 0.8 g/m² (or 1.6 g/m² respectively) of ink is applied to, coated paper test strips mounted on a long rubber-backed platen with a steel printing disk. The pressure of the ink application is 1,000 N and the speed is 1 m/s. The printed strips are dried for 12 hours at 20° C. at 55% minimum room humidity. The gloss is then measured on a Zehntner ZLR-1050 instrument at an incident angle of 75°.

Ink Set Off

The test is carried out on a Pruefbau Test Printing unit. 250 mm³ of ink (Huber no 520068) is distributed for 1 minute on the distributor. A metal printing disk is inked by being placed on the distributor for 15 seconds. The disk is placed on the first printing station. At the second printing station an uninked metal printing disk is placed, with a pressure of 400N. The coated paper strip, mounted on a rubber-backed platen, is printed with a printing pressure of 1000N at a speed of 1.5 m/s. Time 0 is taken when printing happens. After the strip is printed at the first station, move the strip towards second printing station, or set off station, by moving the hand lever. At the set off station, place a blank paper strip between the printed paper and the disk. At 15, 30 60 and 120 seconds, the blank paper is pressed against the printed sample in the set off station by moving the hand lever. The amount of non-immobilized ink from the printed paper transferred to the blank paper is measured by ink densities as given by optical density measurements.

Brightness

Brightness is measured on a Zeiss Elrepho 2000. Brightness is measured according to ISO standard 2469 on a pile of sheets. The result is given as R457.

Opacity

Opacity is measured on a Zeiss Elrepho 2000. Opacity is measured on a single sheet backed by black standard (R₀) and on a pile of sheets (R_{∞}). The result is given as R₀/R_{∞}×100 (percentage).

Burn Out Test

The test is used to illustrate coating distributions and uniformity on unprinted or printed papers (exc. full-tone specimens).

Procedure:

1. Dip the 4×4 cm paper sample for 1 minute into a 10% (weight/weight) aqueous NH₄Cl solution.

2. Dry the test paper for 3 minutes in an oven at 120 degrees Celsius.

3. Char the paper by moving it 5-10 cm over a hot plate until smoke has disappeared (the sample should not burn).

4. Measure Brightness. This procedure stains coating fibers, which appear dark, so a higher brightness value is indicative of improved coverage by the coating, which appears bright compared to the blackened fibers.

Contact Angle

Contact angle is measured with a Fibro 1100 Dynamic Absorption Tester (Fibro Systems AB Sweden) according to method TAPPI T-558.

Dry Pick Resistance (IGT)

This test measures the ability of the paper surface to accept the transfer of ink without picking. The test is carried out on an A2 type printability tester, commercially available from IGT Reprotest BV. Coated paper strips (4-mm×22 mm) are printed with inked aluminum disks at a printing pressure of 36 N with the pendulum drive system and the high viscosity test oil (red) from Reprotest BV. After the printing is completed, the distance where the coating begins to show picking is marked under a stereomicroscope. The marked distance is then transferred into the IGT velocity curve and the velocities in cm/s are read from the corresponding drive curve. High velocities mean high resistance to dry pick.

Paper Roughness

The roughness of the coated paper surface is measured with a Parker PrintSurf roughness tester. A sample sheet of coated paper is clamped between a cork-melinex platen and a measuring head at a clamping pressure of 1,000 kPa. Compressed air is supplied to the instrument at 400 kPa and the leakage of air between the measuring head and the coated paper surface is measured. A higher number indicates a higher degree of roughness of the coated paper surface.

Paper Stiffness

Paper stiffness is measured using the Kodak Stiffness method, TAPPI 535-PM-79, or the Gurely Stiffness method, TAPPI 543.

Coatweight

The coatweight achieved in each coating experiment is calculated from the known volumetric flow rate of the pump delivering the coating to the curtain coating head, the speed at which the continuous web of paper is moving under the curtain coating head, the density and percent solids of the curtain, and the width of the curtain.

Water Resistance

The resistance of the coated paper to coating breakdown after it absorbs water is tested with the Adams Wet rub test. A strip of paper (24×2.5 cm) is fixed onto a bronze wheel, rolling under constant speed and load over a rubber roll, which dips into a pan containing distilled water for either 45 or 60 sec. The rolling makes the water in the pan turbid if the coating breaks down. After the rolling is completed, the light transmission of the water form the pan is measured with a turbidity meter. A low transmission reading indicates significant coating breakdown.

### COMPARATIVE EXPERIMENT A AND EXAMPLES 1 TO 4

These examples use the reaction between borax in one layer, and PVOH in another layer. This reaction leads to a rapid increase in viscosity and the formation of a gel. The details of the formulations are shown in Table 1.

TABLE 1

| | Comparative A | | Example 1 | | Example 2 | | Example 3 | | Example 4 | | |
|---|---|---|---|---|---|---|---|---|---|---|---|
| | Bottom | Top | Bottom | Top | Bottom | Top | Bottom | Top | Bottom | Middle | Top |
| | Layer | Layer | Layer | Layer | Layer | Layer | Layer | Layer | Layer | Layer | Layer |
| Carbonate (A) | 100 | 70 | 100 | 70 | 100 | 70 | | 70 | 100 | | 70 |
| Clay | | 30 | | 30 | | 30 | | 30 | | | 30 |
| Latex (A) | | 11 | | 11 | | 11 | | 11 | | | 11 |
| Latex (B) | 20 | | 20 | | 20 | | | | 20 | | |
| PVOH | | 2.5 | | 2.5 | | 2.5 | | 2.5 | | | 2.5 |
| Latex (C) | 0.5 | | 0.5 | | 0.5 | | 66.4 | | 0.5 | 66.4 | |
| Borax | | | 0.25 | | 0.5 | | 33.3 | | | 33.3 | |
| Whitener | | 1 | 0 | 1 | 0 | 1 | | 1 | | | 1 |
| Surfactant (A) | 0.4 | 0.2 | 0.4 | 0.2 | 0.4 | 0.2 | | 0.2 | 0.4 | | 0.2 |
| pH | 8.5 | 8.5 | 8.5 | 8.5 | 8.5 | 8.5 | 9 | 8.5 | 8.5 | 9 | 8.5 |
| Density (g/cc) | 1.32 | 1.53 | 1.32 | 1.53 | 1.34 | 1.53 | 1.0 | 1.53 | 1.32 | 1.0 | 1.53 |
| Brookfield Viscosity | 100 | 520 | 90 | 520 | 100 | 520 | | 520 | 100 | | 520 |
| (mPa · s) | | | | | | | | | | | |
| Solids % | 45.0 | 62.0 | 45.0 | 62.0 | 45.0 | 62.0 | 1.0 | 62.0 | 45.0 | 1.0 | 62.0 |

The coatings are applied at 1000 m/min onto a wood-containing basepaper with a roughness of 4.3 microns using Coating Procedure 1. Two coating conditions are used for Examples 1, 2 and 3: Coating Condition 1—where the bottom layer coatweight is 1 g/m² and top layer coatweight is 7 g/m and Coating Condition 2—where the bottom layer coatweight is 2 g/m² and top layer coatweight is 6 g/m². These two coating conditions test the effect of increasing the amount of the reactive bottom layer. The comparative experiment uses the same two coating conditions but the reactive ingredient (borax) is left out. Example 4 uses a three-layer coating having a thin middle layer containing the borax. For Example 4, the bottom layer coatweight is fixed at 1 g/m² and the top layer coatweight is 7 g/m² while the coatweight of the middle layer is varied from 0.018 g/m² (Condition 1) to 0.036 g/m² (Condition 2). The coated, paper properties for these examples are shown in Tables 2 and 3.

TABLE 2

| | Comparative A | Example 1 | Example 2 | Example 3 | Example 4 |
|---|---|---|---|---|---|
| Coated Paper Property | Coating | Coating | Coating | Coating | Coating |
| | Condition 1 | Condition 1 | Condition 1 | Condition 1 | Condition 1 |
| PAPER GLOSS 75° (%) | 43 | 43 | 45 | 43 | 37 |
| INK GLOSS 75°; 0.8 | 58 | 62 | 62 | 58 | 51 |
| g/m² INK (%) | | | | | |
| INK GLOSS 75°; 1.6 | 65 | 69 | 68 | 71 | 63 |
| g/m² INK (%) | | | | | |
| ROUGHNESS PPS (μm) | 1.8 | 1.7 | 1.7 | 1.6 | 1.8 |
| ISO BRIGHTNESS R | 76.8 | 78.4 | 77.1 | 77.2 | 78.4 |
| 457 (%) | | | | | |
| OPACITY (%) | 92.8 | 92.8 | 93.5 | 93.6 | 93.8 |
| INK SET OFF AFTER | 0.08 | 0.11 | 0.11 | 0.05 | 0.09 |
| 15 SEC. (Density) | | | | | |
| INK SET OFF AFTER | 0.00 | 0.00 | 0.01 | 0.00 | 0.00 |
| 30 SEC. (Density) | | | | | |
| INK SET OFF AFTER | 0.00 | 0.00 | 0.00 | 0.00 | 0.00 |
| 60 SEC. (Density) | | | | | |
| INK SET OFF AFTER | 0.00 | 0.00 | 0.00 | 0.00 | 0.00 |
| 120 SEC. (Density) | | | | | |
| Burn Out Test | 28.4 | 30.8 | 28.9 | 31.3 | 30.5 |
| Brightness | | | | | |
| Bending Stiffness | 0.050 | 0.049 | 0.055 | 0.056 | 0.060 |
| Machine Direction (mN) | | | | | |

TABLE 3

| | Comparative A | Example 1 | Example 2 | Example 3 | Example 4 |
|---|---|---|---|---|---|
| Coated Paper Property | Coating | Coating | Coating | Coating | Coating |
| | Condition 2 | Condition 2 | Condition 2 | Condition 2 | Condition 2 |
| PAPER GLOSS 75° (%) | 37 | 39 | 41 | 41 | 32 |
| INK GLOSS 75°; 0.8 | 52 | 58 | 56 | 54 | 47 |
| g/m² INK (%) | | | | | |
| INK GLOSS 75°; 1.6 | 63 | 69 | 70 | 62 | 60 |
| g/m² INK (%) | | | | | |
| ROUGHNESS PPS (μm) | 2.0 | 1.8 | 1.7 | 1.4 | 1.9 |
| ISO BRIGHTNESS R | 77.0 | 77.8 | 76.6 | 77.3 | 78.3 |
| 457 (%) | | | | | |
| OPACITY (%) | 92.6 | 93.3 | 92.9 | 92.3 | 93.7 |
| INK SET OFF AFTER | 0.06 | 0.12 | 0.19 | 0.24 | 0.22 |
| 15 SEC. (Density) | | | | | |
| INK SET OFF AFTER | 0.01 | 0.01 | 0.00 | 0.01 | 0.05 |
| 30 SEC. (Density) | | | | | |
| INK SET OFF AFTER | 0.00 | 0.00 | 0.00 | 0.00 | 0.01 |
| 60 SEC. (Density) | | | | | |
| INK SET OFF AFTER | 0.00 | 0.00 | 0.00 | 0.00 | 0.00 |
| 120 SEC. (Density) | | | | | |
| Burn Out Brightness | 27.4 | 27.9 | 29.5 | 29.9 | 29.4 |
| BENDING STIFFNESS | 0.049 | 0.057 | 0.057 | 0.064 | 0.057 |
| MACHINE DIRECTION (mN) | | | | | |

These results show that reaction between the borax and PVOH have a minor effect on paper gloss, a minor effect on paper roughness, a significant improvement in ink gloss, a slowing effect on ink setting, a significant improvement in opacity, a significant improvement in stiffness, a significant improvement in coating coverage determined by the burn out test, and some effect on brightness depending on the thickness of the borax-containing layer. In comparing Coating Condition 1 with Coating Condition 2, it is found that doubling the amount of borax significantly affects the ink set off and stiffness properties.

### COMPARATIVE EXPERIMENT B AND EXAMPLE 5

This example uses a cationic starch in the bottom layer to react with a conventional anionic paper coating top layer. The comparative experiment replaces the cationic starch with a conventional anionic coating starch. The details of the coating formulations are given in Table 4.

TABLE 4

| | Comparative B | | Example 5 | |
|---|---|---|---|---|
| | Bottom Layer | Top Layer | Bottom Layer | Top Layer |
| Carbonate (A) | | 70 | | 70 |
| Clay | | 30 | | 30 |
| Latex (A) | | 11 | | 11 |
| PVOH | | 2.5 | | 2.5 |
| Starch (A) | | | 100 | |
| Starch (B) | 100 | | | |
| Whitener (A) | | 1 | 0 | 1 |
| Surfactant (B) | 2 | 0.4 | 2 | 0.4 |
| pH | 8.5 | 8.5 | 8.5 | 8.5 |
| Density | 1.08 | 1.53 | 1.10 | 1.53 |
| Brookfield | 920 | 580 | 120 | 580 |
| Viscosity | | | | |
| Solids (%) | 20.0 | 62.0 | 20.0 | 62.0 |

The coatings are applied at 1000 m/min to a wood-containing basepaper with a roughness of 6.2 microns using Coating Procedure 1. The bottom layer coatweight is 0.5 g/m² and top layer coatweight is 6.5 g/m². The coated paper properties are in Table 5.

TABLE 5

| Coated Paper Properties | Comparative B | Example 5 |
|---|---|---|
| PAPER GLOSS 75° (%) | 35 | 37 |
| INK GLOSS 75°; 0.8 g/m² INK (%) | 47 | 52 |
| INK GLOSS 75°; 1.6 g/m² INK (%) | 58 | 68 |
| IGT DRY PICK (cm/s) | 52 | 57 |
| INK SET OFF AFTER 15 SEC. (Density) | 0.48 | 0.57 |
| INK SET OFF AFTER 30 SEC. (Density) | 0.20 | 0.25 |
| INK SET OFF AFTER 60 SEC. (Density) | 0.07 | 0.09 |
| INK SET OFF AFTER 120 SEC. (Density) | 0.04 | 0.01 |
| BENDING STIFFNESS MACHINE | 0.042 | 0.050 |
| DIRECTION (mN) | | |

The use of the cationic starch gives a significant improvement in stiffness and coating strength as measured by IGT dry pick. In addition, ink set off gets lower.

### EXAMPLE 6

This example demonstrates an interfacial reaction of a starch-containing formulation with a dialdehyde solution (Glyoxal) capable of reacting with the starch. The starch is formulated into the bottom layer and the Glyoxal solution is the middle-layer. The total Glyoxal used in the formulation is 15% of the starch amount. The top layer of the coating is a conventional pigmented printing layer. A starch—containing two-layer reference without glyoxal is coated as a control. The details of the coating formulations are given in Table 6.

TABLE 6

| Reactive layers | | | | Reference | |
|---|---|---|---|---|---|
| | Starch | Glyoxyal | Top | Starch | Top |
| | Layer | Layer | Layer | Layer | Layer |
| Clay | 0 | 0 | 20 | 0 | 20 |
| Carbonate (A) | 0 | 0 | 80 | 0 | 80 |
| Latex (A) | 0 | 0 | 11 | 0 | 11 |
| Starch (B) | 100 | 0 | 0 | 100 | 0 |
| DSP | 10 | 0 | 0 | 10 | 0 |
| Glyoxal | 0 | 100 | 0 | 0 | 0 |
| PVOH | 0 | 0 | 2.5 | 0 | 2.5 |
| Surfactant (A) | 0.4 | 0 | 0.3 | 0.4 | 0.3 |
| Solids (%) | 30.0 | 10.0 | 63.0 | 24.1 | 63.0 |
| Coatweight | 1 | 0.14 | 12 | 1 | 12 |
| (g/m²) | | | | | |

The coatings are applied at 700 m/min to a wood-containing base paper at the coatweights shown in Table 6 using Coating Procedure 2. Both calendered and uncalendered coated papers are tested for IGT dry pick resistance. The results are shown in Table 7.

TABLE 7

| | IGT (cm/s) |
|---|---|
| Uncalendered | |
| Reference | 95 |
| Glyoxal Containing | 108 |
| Calendered | |
| Reference | 62 |
| Glyoxal Containing | 76 |

The use of the reactive starch/glyoxal system improves the coating strength as measured by IGT dry pick.

The stiffness and the water resistance of the calendered papers are tested with the Gurley Stiffness test (in the cross machine direction) and the Adams Wet Rub test, respectively.

TABLE 8

| | Gurley Stiffness | Wet Rub Result |
|---|---|---|
| Sample | (Gurley units) | (% transmittance) |
| Reference | 375.5 | 4.7 |
| Glyoxal Containing | 397.8 | 83.5 |

The samples with Glyoxal show increased stiffness and excellent water resistance.

### EXAMPLE 7

This example demonstrates the use of a quick setting latex to improve the properties of a coated paper. The trigger for the quick setting reaction is believed to be the conversion of a nitrogen containing polymer from a neutral to a, cationic charged state as the pH changes upon the evaporation of ammonia from the formulation during coating and/or drying of the paper. The details of the formulations are shown in Table 9.

TABLE 9

| | Reactive | | | Comparative | | |
|---|---|---|---|---|---|---|
| Formulation | Bottom | Middle | Top | Bottom | Middle | Top |
| Clay | 100 | 100 | 70 | 100 | 100 | 70 |
| Carbonate (A) | | | 30 | | | 30 |
| Latex (A) | 13 | 13 | | 13 | 13 | |
| Latex (E) | | | 20 | | | |
| Latex (D) | | | | | | 20 |
| PVOH | 1 | 1 | 0.8 | 1 | 1 | 0.8 |
| Surfactant (A) | 0.4 | 0.4 | 0.2 | 0.4 | 0.4 | 0.2 |
| pH | 8.2 | 8.2 | 8.5 | 8.2 | 8.2 | 9.9 |
| Solids (%) | 65.2 | 65.2 | 56 | 65.2 | 65.2 | 47.7 |
| Speed (m/min) | 1000 | | | 1000 | | |
| Coatweight | 6 | 6 | 5 | 6 | 6 | 5 |
| (g/m²) | | | | | | |

The coatings are applied with a 3-layer configuration at 11000 m/min with the coatweights shown in Table 9 onto a wood free basepaper with a basis weight of 120 g/m². Coating Procedure 2 is used. The top layer contains the reactive system. There is no nitrogen-containing polymer in the comparative example. The contact angle is 74° for the papers containing the quick set system, and is 64° for the comparative paper. The quick set polymer apparently forms a combination of hydrophobic linkages that render the paper more water resistant.

### EXAMPLE 8

This example demonstrates coating using an amino-ethoxysilane (Ameo) and a glycidyl functionalized ethoxysilane (Glyeo). Multiple reactions can occur. In addition to the reaction between the amino group and the glycidyl group, a hydrolysis/condensation reaction takes place via the glycidyl-functionalized silane reacting with itself to form a siloxane linkage when the pH is sufficiently high to hydrolyze the ethoxysilane. Three-approaches for coating the paper are demonstrated. First, the self-reaction of the Glyeo is demonstrated. Then, in addition to the self-reaction, a simultaneous interfacial reaction is demonstrated with the reaction between Ameo and Glyeo occurring in a layered structure. Third, an in-line approach is used, where a blend of Ameo and Glyeo is fed to a single layer slot of the die. The details of the formulations are shown in Table 10.

TABLE 10

| | | | Multi layer | | | In Line |
|---|---|---|---|---|---|---|
| Formulation | Control | Glyeo | Glyeo/Ameo/Glyeo | | | Glyeo/Ameo |
| Carbonate (A) | 100 | 100 | 100 | 100 | 100 | 100 |
| Latex (F) | 11 | 11 | 11 | 11 | 11 | 11 |
| Ameo | | | | 1.5 | | 1.5 |
| Glyeo | | 1.5 | 3 | | 3 | 3 |
| Surfactant (A) | 0.4 | 0.4 | 0.2 | | 0.4 | 0.6 |
| Solids (%) | 64.9 | 64 | 63.2 | 63.9 | 63.1 | 66.1 |
| Speed | 700 | 700 | 700 | | | 700 |
| (m/min) | | | | | | |
| Coatweight | 17 | 17 | 4.5 | 9 | 4.5 | 18 |
| (g/m²) | | | | | | |

The coatings are applied to wood-containing base paper using Coating Procedure 2. Coatweight and coater speed are as shown in Table 10. Uncalendered and calendered paper gloss are as shown in Table 11, which also includes a comparison of the ink gloss results. Paper gloss is reduced with these reactive systems. The ink gloss is significantly improved. The improvement is greatest for the calendered papers. The reacted samples show an improvement in the delta between the ink gloss and sheet gloss for two ink loads.

TABLE 11

| | | | Glyeo | Glyeo | | | Glyeo | Glyeo |
|---|---|---|---|---|---|---|---|---|
| | | | Ameo | Ameo | | | Ameo | Ameo |
| | | | Multi- | inline | | | Multi- | inline |
| Sample | Control | Glyeo | layer | blend | Control | Glyeo | Layer | blend |
| Calendered | No | No | no | no | yes | yes | Yes | yes |
| Paper Gloss 75° | 30 | 24 | 25 | 27 | 75 | 69 | 67 | 69 |
| Ink Gloss 75° | 52 | 54 | 52 | 53 | 75 | 85 | 84 | 85 |
| at 1.6 g/m² | | | | | | | | |
| load | | | | | | | | |
| Ink Gloss 75° | 46 | 46 | 47 | 47 | 72 | 80 | 77 | 82 |
| at 0.8 g/m² | | | | | | | | |
| load | | | | | | | | |

Adams wet rub resistance of the paper surfaces is measured for both uncalendered and calendered samples. The resulting turbidity measurements for two rub times are shown in Table 12, which also shows the contact angle measurement. The results show the increased water resistance of the coating compared to an unreacted control.

TABLE 12

| | | Adams | Adams | |
|---|---|---|---|---|
| | | wet rub | wet rub | |
| | | Run time: 60 s | Run time: 45 s | Contact |
| | | (% | (% | Angle |
| Run | | transmittance) | transmittance) | (degrees) |
| Control | Uncalendered | 26.7 | 32.6 | 58.5 |
| Glyeo | | 92.3 | 95 | 60.7 |
| Multi | | 90.2 | 95 | 78 |
| Layer | | | | |
| In Line | | 84.0 | 92.6 | 73.9 |
| Blend | | | | |
| Control | Calendered | | 49.3 | 61.6 |
| Glyeo | | | 87.9 | 63.4 |
| Layer | | | | |
| Multi | | | 93.8 | 77.5 |
| In Line | | | 91.8 | 73.6 |
| Blend | | | | |

Water resistance is increased for paper coated with the Glyeo, and for the Glyeo plus Ameo reactive systems. The highest contact angle is obtained when both reactive functionalities are present.

### EXAMPLE 9

This example demonstrates the reaction between an amino-based epoxy curing agent and an epoxide. This example uses an in-line approach, where a blend of curing agent and the epoxide is fed to a single layer slot of the die. The reference sample does not contain the hardener or the epoxide. The details of the formulations are shown in Table 13.

TABLE 13

| | | | Epoxy/Hardener | | |
|---|---|---|---|---|---|
| | Reference | | | Layer 2 In Line | |
| Formulation | Layer 1 | Layer 2 | Layer 1 | Blend | |
| Carbonate (A) | 100 | | 100 | | |
| Latex (A) | 13 | 99.8 | 13 | | |
| PVOH | 1 | | 1 | | |
| Epoxy | | | | | 99.8 |
| Hardener | | | | 99.8 | |
| Surfactant (A) | 0.4 | 0.2 | 0.4 | 0.2 | 0.2 |
| Solids (%) | 65.2 | 49.4 | 65.2 | 36.7 | 53.7 |
| Speed (m/mm) | 1000 | | 1000 | | |
| Coatweight (g/m²) | 24 | 3 | 24 | 0.6 | 1.8 |

The formulations are applied to a wood-containing base paper at the coater speeds and coatweights indicated in Table 13 using Coating Procedure 2. After drying the papers on the machine, the samples are further cured for 15 minutes at 120° C. to complete the reaction. Contact angle and paper stiffness are measured. The results are shown in Table 14.

TABLE 14

| | Reference | Epoxy/Hardener |
|---|---|---|
| Contact Angle | 60.5 | 78.2 |
| (degree) | | |
| Paper Stiffness (mNm) | 0.778 | 0.993 |

The water resistance and stiffness of the coated paper increases with the epoxy/hardener reaction.

### EXAMPLE 10

This example demonstrates the reaction between an isocyanate and polyol to form a polyurethane layer in a multilayer structure. The example uses an in-line blend of the reactive chemicals before entering the die of the coater. Details of the formulations are shown in Table 15.

TABLE 15

| | Reactive | | | | | | |
|---|---|---|---|---|---|---|---|
| | | Middle in Line | | | Comparative | | |
| Formulation | Bottom | Blend | | Top | Bottom | Middle | Top |
| Carbonate | 70 | | | 70 | 100 | 50 | 70 |
| (A) | | | | | | | |
| Clay | 30 | | | 30 | | | 30 |
| Carbonate | | | | | | 50 | |
| (B) | | | | | | | |
| Latex | 11 | | | 11 | 13 | 10 | 11 |
| (A) | | | | | | | |
| PVOH | 0.8 | | | 0.8 | 1 | 0.8 | 0.8 |
| Thickener | 0.1 | | | 0.1 | 0.1 | 0.1 | 0.1 |
| Isocyanate | | 23 | | | | | |
| Polyethylene | | | 7 | | | | |
| Oxide | | | | | | | |
| Catalyst | | | 0.02 | | | | |
| Whitener | 1 | | | 1 | | 1 | 1 |
| Surfactant | 0.4 | | | 0.4 | 0.4 | | 0.2 |
| (A) | | | | | | | |
| Solids (%) | 62 | 100 | 100 | 62 | 60 | 70 | 62 |
| Speed | 1000 | | | | 1000 | | |
| (m/min) | | | | | | | |
| Coatweight | 3 | 6 | 2 | 10 | 3 | 6 | 5 |
| (g/m²) | | | | | | | |

The coatings are applied to wood containing base paper using Coating Procedure 2. Resulting paper properties are shown in Table 16.

TABLE 16

| | Reactive | Comparative |
|---|---|---|
| Adams Wet Rub | 99.3 | 32.8 |
| (% transmittance) | | |
| Dry Pick Resistance | No Pick | 46 |
| (cm/s) | | |
| Uncalendered Gloss | 45 | 28 |

The paper containing the polyurethane shows good dry pick resistance and good water resistance. The polyurethane also enhances the uncalendered gloss.

What is claimed is:

1. A method of producing a coated substrate comprising the steps of:
a) forming a free flowing curtain, the curtain having a first component and a second component capable of reacting with each other, and
b) contacting the curtain with a continuous web substrate.

2. The method of claim 1, wherein the method comprises the steps of:
a) forming a composite, multilayer free flowing curtain, the curtain having at least two layers, whereby one layer comprises a first component which is capable of reacting with a second component in a different layer, and
b) contacting the curtain with a continuous web substrate.

3. The method of claim 2, wherein in the multilayer free flowing curtain of step a) at least one internal layer is present between the layer comprising the first component and the layer comprising the second component.

4. The method of claim 1, wherein the reaction type of which the first component and the second component of step a) react with each other is selected from the group consisting of anionic-cationic-interaction, crosslinking reaction, free radical reaction, step growth reaction, addition reaction, UV induced curing reaction, electron beam induced curing reaction, acid-base reaction, flocculation/coagulation reaction and combinations thereof.

5. The method of claim 1, comprising the steps of:
a) forming a free flowing curtain, the curtain having at least one layer comprising a composition capable of reacting, and
b) contacting the curtain with a continuous web substrate.

6. The method, of claim, 5, comprising the steps of:
a) forming a free flowing curtain, the curtain having at least one layer comprising a first component and a second component capable of reacting with each other, and
b) contacting the curtain with a continuous web substrate.

7. The method of claim 1, characterized in that in step a) the first component is an amino silane ester and the second component is a gylcidyl silane ester.

8. The method of claim 1, wherein the free flowing curtain of step a) is a composite, multilayer free flowing curtain.

9. The method of claim 1, wherein the reaction between the first component and the second component of step a) takes place in the free flowing curtain and/or when applied to the substrate and/or when initiated by heat, pressure, radiation, and/or oxygen.

10. The method of claim 1, wherein in step a) the first component is a polyvinyl alcohol and the second component is borax.

11. The method of claim 1, wherein in step a) the first component is cationic starch and the second component is an: anionic coating composition.

12. The method of claim 1, wherein the free flowing curtain of step a) comprises a top layer ensuring printability.

13. The method of claim 1, wherein the continuous web substrate of step b) has a grammage of from about 20 to about 400 g/m².

14. The method of claim 1, wherein at least one of the layers of the multilayer curtain of step a) has a coatweight when dried of less than about 30 g/m².

15. The method of claim 1, wherein the multilayer curtain of step a) has a coatweight when dried of less than about 60 g/m².

16. The method of claim 1, wherein the multilayer curtain of step a) comprises at least 3 layers.

17. The method of claim 1, wherein the multilayer curtain of step a) comprises at least one layer comprising at least one pigment.

18. The method of claim 17, wherein the pigment is selected from the group consisting of clay, kaolin, calcined clay, talc, calcium carbonate, titanium dioxide, satin white, synthetic polymer pigment, zinc oxide, barium sulfate, gypsum, silica, alumina trihydrate, mica, and diatomaceous earth.

19. The method of claim 1, wherein at least one layer of the multilayer free flowing curtain of step a) comprises a binder.

20. The method of claim 19, wherein the binder is selected from the group consisting of styrene-butadiene latex, styrene-acrylate latex, styrene-acrylate-acrylonitrile latex, styrene-butadiene-acrylate-acrylonitrile latex, styrene-butadiene-acrylate-acrylonitrile latex, styrene-maleic anhydride latex, styrene-acrylate-maleic anhydride latex, polysaccharides, proteins, polyvinyl pyrollidone, polyvinyl alcohol, polyvinyl acetate, cellulose derivatives and mixtures thereof.

21. The method of claim 1, wherein at least one layer of the multilayer free flowing curtain of step a), comprises at least one optical brightening agent.

22. The method of claim 1, wherein at least one layer of the multilayer free flowing curtain of step a) comprises at least one surfactant.

23. The method of claim 1, wherein at least one layer of the multilayer free flowing curtain of step a) has a solids content of at least about 40 wt. %.

24. The method of claim 1, wherein the multilayer free flowing curtain of step a) has a solids content of at least about 10 wt. %.

25. The method of claim 1, wherein the continuous web substrate of step b) is a basepaper or a paperboard.

26. The method of claim 1, wherein the continuous web substrate of step b) is neither precoated nor precalendered.

27. The method of claim 1, wherein the continuous web substrate of step b) has a web velocity of at least about 300 m/min.

28. A coated substrate obtainable by the method of claim 1.

29. A coated substrate according to claim 28, wherein the coated substrate is coated paper or paperboard.

30. A process for producing a coated substrate comprising the steps of:
a) forming a free flowing curtain, the curtain having at least one component capable of reacting with itself or another compound, and
b) contacting the curtain with a continuous web substrate,
wherein at least one component of the curtain begins reacting during the coating process and is essentially completely reacted before the coating process is complete.

31. The method of claim 30, comprising the steps of:
a) forming a free flowing curtain, the curtain having at least one layer comprising a first component and a second component capable of reacting with each other, and
b) contacting the curtain with a continuous web substrate.

32. The method of claim 30, wherein the free flowing curtain of step a) is a composite, multilayer free flowing curtain.

33. The method of claim 31, wherein the reaction type of which the first component and the second component of step a) react with each other is selected from the group consisting of anionic-cationic-interaction, free radical reaction, step growth reaction, addition reaction, UV induced curing reaction, electron beam induced curing reaction, acid-base reaction, flocculation/coagulation reaction and combinations thereof.

34. The method of claim 31, wherein the reaction between the first component and the second component of step a) takes place in the free flowing curtain and/or when applied to the substrate and/or when initiated by heat, radiation, and/or oxygen.

35. The method of claim 30, wherein the free flowing curtain of step a) comprises a top layer ensuring printability.

36. The method of claim 32, wherein at least one of the layers of the multilayer curtain of step a) has a coatweight when dried of less than about 30 g/m².

37. The method of claims 32, wherein the multilayer curtain of step a) has a coatweight when dried of less than about 60 g/m².

38. The method of claim 32, wherein the multilayer curtain of step a) comprises at least 3 layers.

39. The method of claim 32, wherein the multilayer curtain of step a) comprises at least one layer comprising at least one pigment.

40. The method of claim 39, wherein the pigment is selected from the group consisting of clay, kaolin, calcined clay, talc, calcium carbonate, titanium dioxide, satin white, synthetic polymer pigment, zinc oxide, barium sulfate, gypsum silica, alumina trihydrate, mica, and diatomaceous earth.

41. The method of claim 32, wherein at least one layer of the multilayer free flowing curtain of step a) comprises a binder.

42. The method of claim 41, wherein the binder is selected from the group consisting of styrene-butadiene latex, styrene-acrylate latex, styrene-acrylate-acrylonitrile latex, styrene-butadiene-acrylate-acrylonitrile latex, styrene-maleic anhydride latex, styrene-acrylate-maleic latex, styrene-acrylate-maleic anhydride latex, polysaccharides, proteins, polyvinyl pyrollidone, polyvinyl alcohol, polyvinyl acetate, cellulose derivatives and mixtures thereof.

43. The method of claim 32, wherein at least one layer of the multilayer free flowing curtain of step a) comprises at least one optical brightening agent.

44. The method of claim 32, wherein at least one layer of the multilayer free flowing curtain of step a) comprises at least one surfactant.

45. The method of claim 32, wherein at least one layer of the multilayer free flowing curtain of step a) has a solids content of at least about 40 wt. %.

46. The method of claim 32, wherein the multilayer free flowing curtain of step a) has a solids content of at least about 10 wt. %.

47. The method of claim 30, wherein the continuous web substrate of step b) is a basepaper or a paperboard.

48. The method of claim 30, wherein the continuous web substrate of step b) is neither precoated nor precalendered.

49. The method of claim 30, wherein the continuous web substrate of step b) has a web velocity of at least about 300 m/min.

50. The method of claim 30, wherein the continuous web substrate of step b) has a grammage of from about 20 to about 400 g/m².

51. A coated substrate obtainable by the method of claim 30.

52. A coated substrate according to claim 30, wherein the coated substrate is coated paper or paperboard.

53. The method of claim 30, wherein the curtain contains one reactive component, and wherein the reaction of the reactive component is initiated by an initiating means external to the curtain selected from the group consisting of heat, radiation, pressure, or a combination thereof.

54. The method of claim 1, wherein the multilayer curtain of step a) comprises at least 4 layers.

55. The method of claim 1, wherein the multilayer curtain of step a) comprises at least 5 layers.

56. The method of claim 1, wherein the multilayer curtain of step a) comprises at least 6 layers.

57. The method of claim 1, wherein the continuous web substrate of step b) has a web velocity of at least about 400 m/min.

58. The method of claim 1, wherein the continuous web substrate of step b) has a web velocity of at least about 500 m/min.

59. The method of claim 32, wherein the multilayer curtain of step a) comprises at least 4 layers.

60. The method of claim 32, wherein the multilayer curtain of step a) comprises at least layers.

61. The method of claim 32, wherein the multilayer curtain of step a) comprises at least 6 layers.

62. The method of claim 30, wherein the continuous web substrate of step b) has a web velocity of at least about 400 m/min.

63. The method of claim 30, wherein the continuous web substrate of step b) has a web velocity of at least about 500 m/min.

64. The method of claim 1, wherein the curtain is formed with a slot die.

65. The method of claim 1, wherein the curtain is formed with a slide die.

66. The method of claim 1, wherein at least one layer of the curtain comprises polyethylene oxide.

67. The method of claim 1, wherein the curtain comprises polyethylene oxide in the interface layer.

68. The method of claim 30, wherein the curtain is formed with a slot die.

69. The method of claim 30, wherein the curtain is formed with a slide die.

70. The method of claim 30, wherein at least one layer of the curtain comprises polyethylene oxide.

71. The method of claim 30, wherein the curtain comprises polyethylene oxide in the interface layer.

72. A method of claim 1, characterized in that in step a) the first component is a starch and the second component is a dialdehyde.

73. A method of claim 1, characterized in that in step a) the first component is an epoxy-functional polymer and the second component is an amine hardening agent.

74. A method of claim 1, characterized in that in step a) the first component is a polyol and the second component is a polyisocyanate.
